(19) United States
(12) Patent Application Publication
(10) Pub. No.: US 2008/0268678 A1
(43) Pub. Date: Oct. 30, 2008

(54) UNIVERSAL SERIAL BUS HUB INTEGRATED WITH ROTATING MECHANISM

(75) Inventor: Chi-Chien Hsu, Taoyuan County (TW)

Correspondence Address: SHOEMAKER AND MATTARE, LTD, 10 POST OFFICE ROAD - SUITE 110, SILVER SPRING, MD, 20910, US

(73) Assignee: GOOD MAN CORPORATION, Taoyuan County (TW)

(21) Appl. No.: 11/741,552

(22) Filed: Apr. 27, 2007

(51) Int. Cl. H01R 39/00

(52) U.S. Cl. 439/131

(57) ABSTRACT

A rotating mechanism is disclosed, which includes a first component formed with a first opening and a first retention portion disposed on one edge of the first opening; a second component formed with a second opening to correspond to and stack up with the first opening to form an action hole, a second retention portion disposed on one edge of the second opening corresponding to the first opening; and a fastening member having a connecting portion and an elastic hooking portion, wherein the connecting portion couples to one edge of the action hole and the elastic hooking portion penetrates through the action hole to hook onto the other edge of the action hole, thereby rotating the second component to couple to the first component. The invention further provides an improved USB hub having the rotating mechanism that includes first and second rotating bodies each having connecting ports disposed thereon for coupling to the first and second components respectively.

### BACKGROUND OF THE INVENTION

1. Field of the Invention

The present invention generally relates to a fastening technique, and more particularly to a rotating mechanism and an improved USB hub having the rotating mechanism.

2. Description of the Prior Art

As computer systems have become more common in the workplace and in the home, there has become a need to make these computer systems more adaptable and interchangeable to allow the customization of a computer system to a particular user's needs.

The success of the USB interface created a new horizon of connectivity for computer peripherals as USB ports are the connectors of the present peripherals in order to achieve the goal of plug-and-play. As the USB port provided by a computer is limited, USB hub is used to increase the number of the ports. While the capability of the USB hub being enhanced, the look-and-feel of the hub is usually neglected in that a plurality of wired USB connectors and wireless peripherals all plug into the USB hub whose connecting ports are positioned to align with one another, making the related cables confusing or tangled, which not only causes plug-in inconvenient but also makes the scenes disorderly and unsightly, since a host computer having network wires may be located at various directions or even on different floors.

Moreover, the conventional USB hub with connecting ports being aligned together in a row does not provide smooth plug-in and secure connection for large-scale USB devices such as a MP3 that have relatively large size in that the connecting ports located on two sides thereof are often interfered by plug-ins and thus become unusable. Even if the connecting ports of the hub are posited on different sides, such as a six-sided hub having connecting ports disposed on the two sides thereof, the other side is often difficult to move or immobile when the connecting ports disposed on one of the two sides are being used, and thus does not ease and assure an accurate

plug-in of the connecting ports on the other side of the USB hub.

Therefore, there is a need for an improved mechanism that provides multiple plug-ins in a single USB hub in a personal computer.

### SUMMARY OF THE INVENTION

In view of the drawbacks of the traditional USB hub, the main objective of the present invention is to provide a rotating mechanism and an improved USB hub having the rotating mechanism that facilitate a smooth plug-in and secure connection in the hub.

Another object of the present invention is to provide a rotating mechanism and an improved USB hub having the rotating mechanism that prevent the connecting ports of the peripherals plugged-in the hub from interfering with one another.

To achieve the above-mentioned objectives, the rotating mechanism of the present invention comprises a first component formed with a first opening and a first retention portion disposed on one edge of the first opening; a second component formed with a second opening to correspond to and stack up with the first opening to form an action hole, a second retention portion disposed on one edge of the second opening corresponding to the first opening, for allowing the second component to rotate with respect to the first component to fasten the second retention portion onto the first retention portion; and a fastening member having a connecting portion and an elastic hooking portion, wherein the connecting portion couples to one edge of the action hole and the elastic hooking portion penetrates through the action hole to hook onto the other edge of the action hole, thereby rotating the second component to couple to the first component.

The present invention further provides an improved USB hub having the rotating mechanism described above, comprising: a first rotating body having the connecting ports disposed on at least one side surface thereof while a first connecting portion being disposed on another side surface without connecting ports being disposed thereon; a second rotating body having connecting ports disposed on at least one side surface thereof while a second connecting portion being disposed on another side surface with connecting ports being disposed thereon; a first component formed with a first opening and a first retention portion disposed on the edge of the first opening, and a third connecting portion disposed at an opposite side of the first retention portion for correspondingly coupling to the first connecting portion; a second component formed with a second opening to correspond to and stack up with the first opening to form an action hole, a plurality of second retention portions disposed on the edge of the second opening corresponding to the first retention portion, and a fourth connecting portion disposed at an opposite side of the first retention portion for correspondingly coupling to the second connecting portion; and a fastening member having a connecting portion and an elastic hooking portion, wherein the connecting portion couples to one edge of the action hole and the elastic hooking portion penetrates through the action hole to hook onto the other edge of the action hole, thereby rotating the second component to couple to the first component.

In contrast to the known USB hub with the connecting ports being aligned in one row, the characteristics of the present invention lies in the rotating mechanism that allows the first and second rotating bodies to rotate with respect to one another, such that the direction of opening can be altered by rotating the rotating bodies to facilitate smooth plug-in and secure connection from all directions, thereby preventing adjacent connecting ports in a hub from interfering with one another as encountered in prior techniques.

Note that the present invention is not limited to the configuration of first and second rotating bodies as described above, the first and second rotating bodies are expandable to combine with additional rotating bodies having connecting ports disposed thereon for expansion purposes. Accordingly, the rotating mechanism and the improved USB hub of the present invention offer advantages over the prior art and have high industrial applicability.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded view of a first preferred embodiment of a rotating mechanism and an improved USB hub having the rotating mechanism according to the present invention;

FIG. 2 is an exploded view of the rotating mechanism according to the present invention;

FIG. 3 is a perspective view of a second preferred embodiment of the improved USB hub according to the present invention; and

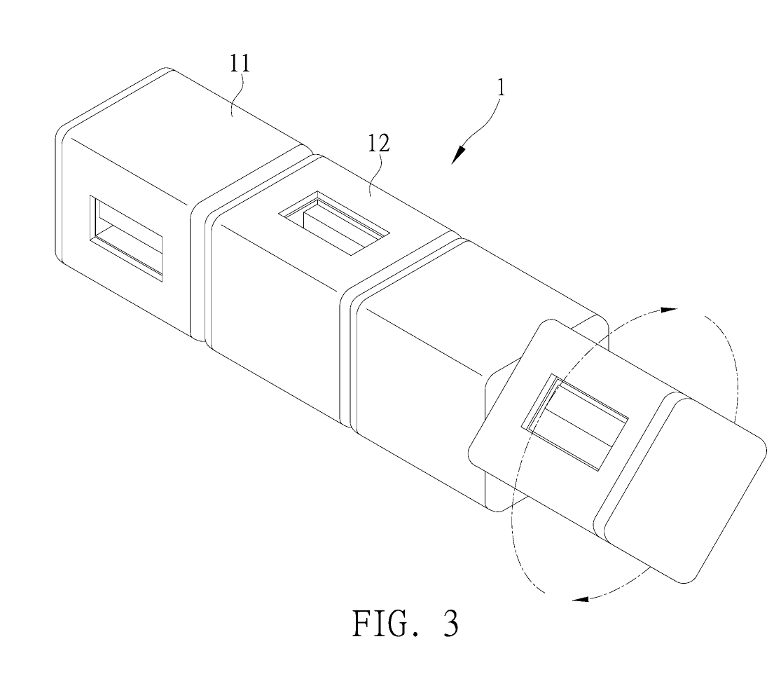

FIG. 4 is another perspective view of the USB hub according to the present invention.

### DETAILED DESCRIPTION OF THE PREFERRED EMBODIMENT

In order to illustrate the present invention particularly, including technology, structure traits, aims and efficiency, a detailed explanation of a preferred embodiment of the present invention will be given thereinafter, with reference to the annexed drawings, for better understanding thereof to those skilled in the art.

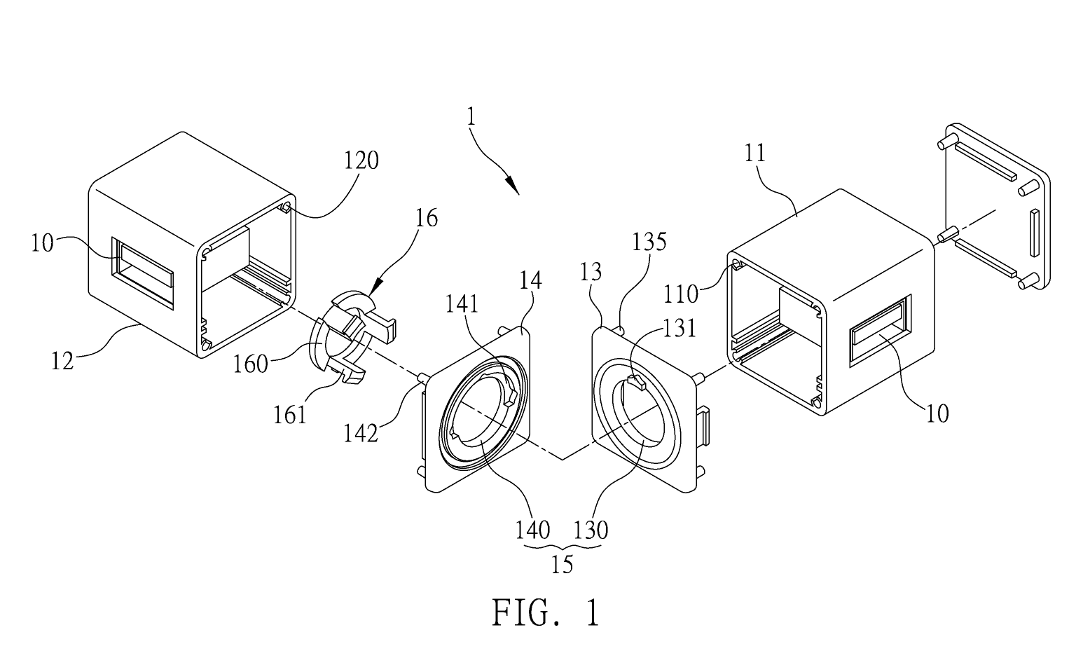

Referring to the drawings in greater detail, and first to FIG. 1, the USB hub 1 of the present invention comprises a first rotating body 11 having connecting ports 10 disposed on at least one side surface thereof while a first connecting portion 110 being disposed on another side surface without connecting ports 10 being disposed thereon; a second rotating body 12 having connecting ports 10 disposed on at least one side surface thereof while a second connecting portion 120 being disposed on another side surface without connecting ports being disposed thereon; a first component 13 formed with a first opening 130 and a first retention portion 131 disposed on the edge of the first opening 130, and a third connecting portion 132 disposed at an opposite side of the first retention portion 131 for correspondingly coupling to the first connecting portion 110; a second component 14 formed with a second opening 140 to correspond to and stack up with the first opening 130 to form an action hole 15, a plurality of second retention portions 141 disposed on the edge of the second opening 14 corresponding to the first retention portion 131, and a fourth connecting portion 142 disposed at an opposite side of the first retention portion 131 for correspondingly coupling to the second connecting portion 120; and a fastening member 16 having a connecting portion 160 and an elastic hooking portion 161, wherein the connecting portion 160 couples to one edge of the action hole 15 and the elastic hooking portion 161 penetrates through the action hole 15 to hook onto the other edge thereof, thereby rotating the second component 14 to couple to the first component 13. In other words, the rotating mechanism constituted by the first component 13, the second component 14 and the fastening member 16 enables the second rotating body 12 to rotate and couple to the first rotating body 11.

The first connecting portion 110 of the first rotating body 11 may be a connecting hole disposed at corners of the inner housing of the first rotating body 11. The third connecting portion 132 of the first component 13 may be a protruding pin disposed at corners on one side of the first component 13. Similarly, the second connecting portion 120 of the second rotating body 12 may be a connecting hole and the fourth connecting portion 142 of the second component 14 may be a protruding pin, and the second component 14 or the first component 13 may further include additional structures to strengthen the first or second rotating bodies 11, 12. For instance, one side of the protruding pin disposed on the first component 13 may include an elastic piece 133 and a connecting piece 134 to support the two sides of the inner housing of the first rotating body 11.

The connecting ports 11 are disposed on at least one side surface surrounding the rotating pivot of the first and second rotating bodies 11, 12. Naturally, the connecting ports 10 can be disposed on the side surface of the two sides of the rotating pivot of the first and second rotating bodies 11, 12.

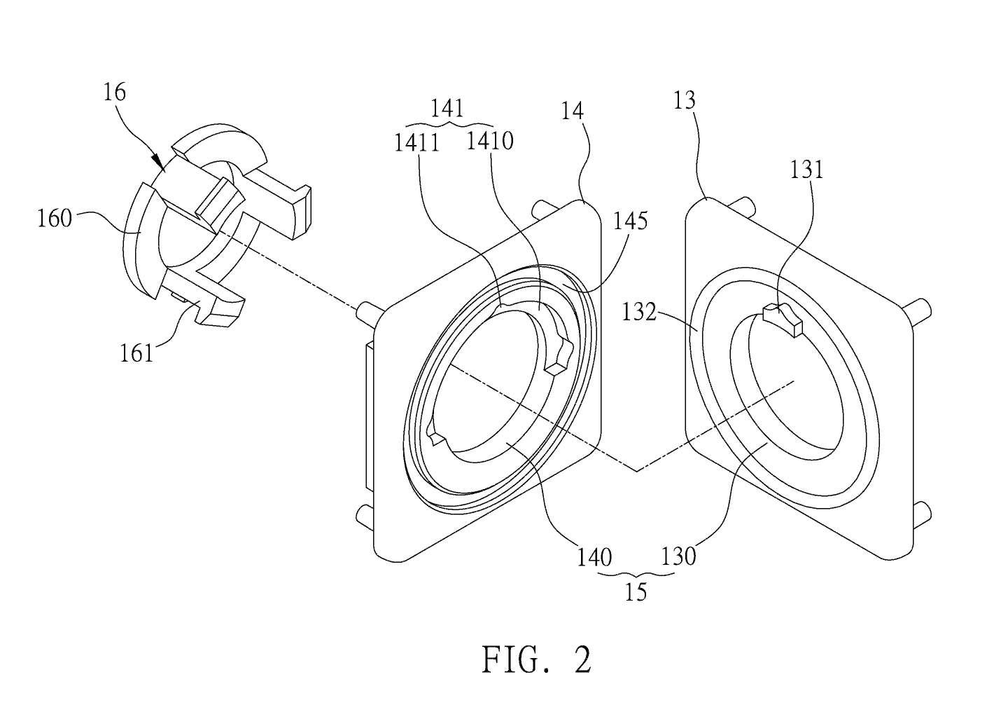

Referring to FIG. 2, the first retention portion 131 is a bump, and the second retention portion 141 is constituted by sliding grooves 1410 disposed along the periphery of the second opening 140 and a plurality of retention recesses concavely disposed on a side wall of the sliding groove 1410, allowing the second component 14 to rotate with respect to the first component 13 to position and couple the second retention portion 141 onto the first retention portion 131. The sliding groove 1410 may surround to cover half of the periphery of the second opening 140 to allow the first rotating body 11 to rotate by 180 degrees with respect to the second rotating body 12, wherein there are three retention recesses 1411 each concavely disposed on the two ends and the center of the sliding groove 1410 respectively. Note that the configuration of the retention structures of the first and second components 13, 14 can be switched according to the actual application.

The connecting portion 160 of the fastening member 16 is a ring. The elastic hooking portion 161 is an extending arm disposed at one side of the ring and having a protruding wedge disposed at the end thereof. The connecting portion 160 may couple to the first opening 130 of the first component 13 to enable the elastic hooking portion 161 to hook up to the second opening 140 of the second component 14. Similarly, the connecting portion 160 may also couple to the second opening 140 of the second component 14 to enable the elastic hooking portion 161 to hook up to the first opening 130 of the first component 13.

To facilitate smooth rotation and secure connection of the first and second rotating components 13, 14, the first component 13 may include a protruding ring surrounding the first opening 13 while the second component 14 has a recessive ring 145 surrounding the second opening 140 to correspond to the protruding ring 132.

Further, the action hole 15 constituted by the first and second openings 130, 140 allows the wires connecting between the first and second rotating bodies 11, 12 to pass through.

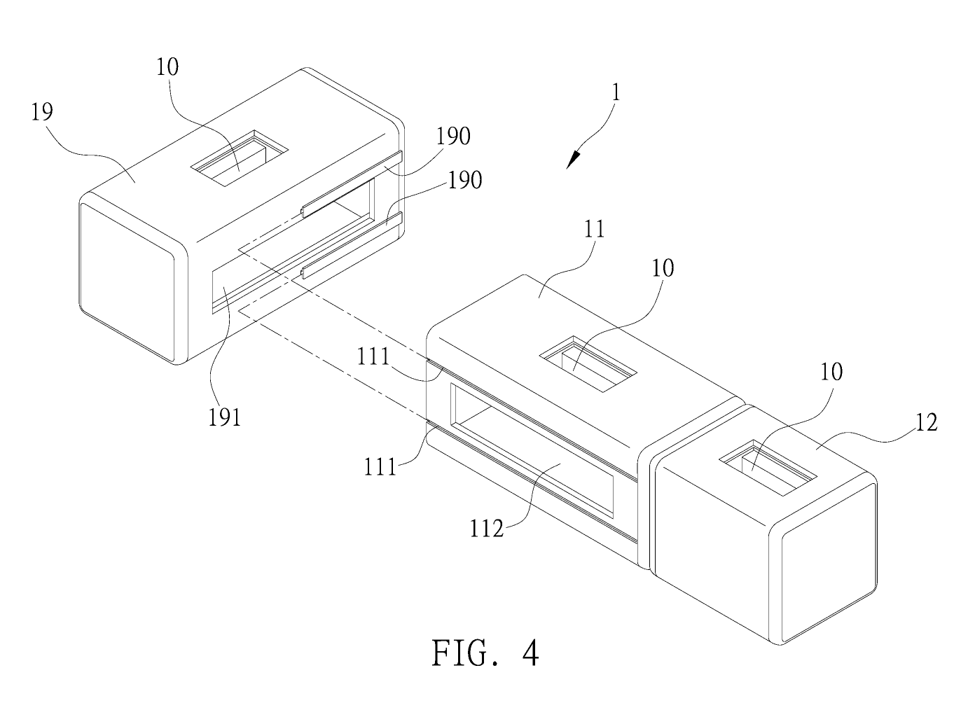

Referring to FIG. 4, the first rotating body 11 has a relatively longer length and a first sliding connecting portion 111 disposed on the longer side thereof to slide along and couple to a sliding block 19 having the connecting ports disposed thereon. The sliding block 19 has a second sliding connecting portion 190 corresponding to the first sliding connecting portion 111, wherein the first sliding connecting portion 111 may be a recessive groove having a corresponding length to the first rotating body 11 while the second sliding connecting portion 190 is a protruding rib having only half of the length of the recessive groove in order to slide and couple to one side of the first rotating body 11 for the ease of using the hub 1. Further, the side surface combining the first rotating body 11 with the sliding block 190 may be formed with openings 112, 191 respectively for allowing the connecting wires to pass through.

Compared to the conventional USB hub with the connecting ports being aligned in a row, the characteristics of the present invention lies in the rotating mechanism that allows the first and second rotating bodies 11, 12 to rotate with respect to one another to alter the direction of opening by rotating the rotating bodies to facilitate smooth plug-in and secure connection from all directions, thereby preventing adjacent connecting ports in a hub from interfering with one another as suffered in prior techniques.

Note that the present invention is not limited to the combination of first and second rotating bodies 11, 12 as described above, the first and second rotating bodies are expandable to combine with additional rotating bodies having the connecting ports disposed thereon. Accordingly, the rotating mechanism and the improved USB hub offer advantages over the prior art and have high industrial applicability.

Although a particular embodiment of the invention has been described in detail for purposes of illustration, coverage of this patent is not limited thereto. On the contrary, this patent covers all embodiments of the teachings of the invention falling fairly within the scope of the appended claims, either literally or under the doctrine of equivalents.

1. A rotating mechanism, comprising:
a first component formed with a first opening and a first retention portion disposed on one edge of the first opening;
a second component formed with a second opening to correspond to and stack up with the first opening to form an action hole, a second retention portion being disposed on one side edge of the second opening corresponding to the first opening, for allowing the second component to rotate with respect to the first component to fasten the second retention portion onto the first retention portion; and
a fastening member having a connecting portion and an elastic hooking portion, wherein the connecting portion couples to one edge of the action hole and the elastic hooking portion penetrates through the action hole to hook onto the other edge of the action hole, thereby rotating the second component to couple to the first component.

2. The rotating mechanism according to claim 1, wherein the first retention portion is a bump, and the second retention portion is constituted by a plurality of sliding grooves disposed along the periphery of the second opening and retention recesses disposed on the side wall of the sliding groove.

3. The rotating mechanism according to claim 2, wherein the sliding grooves surround half of the periphery of the second opening, and there are three retention recesses each disposed on the two sides and the center of the sliding groove respectively.

4. The rotating mechanism according to claim 1, wherein the connecting portion couples to the first opening of the first component and the elastic hooking portion hooks up to the second opening of the second component.

5. The rotating mechanism according to claim 1, wherein the connecting portion couples to the second opening of the second component and the elastic hooking portion hooks up to the first opening of the first component.

6. The rotating mechanism according to claim 1, wherein the connecting portion is a ring, and the elastic hooking portion is an extending arm disposed at one side of the ring and having a protruding wedge disposed at the end thereof.

7. The rotating mechanism according to claim 1, wherein the first component comprises a protruding ring surrounding the first opening while the second component has a recessive ring surrounding the second opening for corresponding to the protruding ring.

8. A universal serial bus (USB) hub, comprising:
a first rotating body having connecting ports disposed on at least one side surface thereof while a first connecting portion being disposed on another side surface having no connecting ports disposed thereon;
a second rotating body having connecting ports disposed on at least one side surface thereof while a second connecting portion being disposed on another side surface having no connecting ports disposed thereon;
a first component formed with a first opening and a first retention portion disposed on the edge of the first opening, and a third connecting portion disposed at an opposite side of the first retention portion for correspondingly coupling to the first connecting portion;
a second component formed with a second opening to correspond to and stack up with the first opening to form an action hole, a plurality of second retention portions disposed on the edge of the second opening corresponding to the first retention portion, and a fourth connecting portion disposed at an opposite side of the second retention portion for correspondingly coupling to the second connecting portion; and
a fastening member having a connecting portion and an elastic hooking portion, wherein the connecting portion couples to one edge of the action hole and the elastic hooking portion penetrates through the action hole to hook onto the other edge of the action hole, thereby rotating the second component to couple to the first component.

9. The USB hub according to claim 8, wherein the first connecting portion of the first rotating body is a connecting hole disposed at corners of an inner housing of the first rotating body, and the third connecting portion of the first component is a protruding pin disposed at corners of one side of the first component.

10. (canceled)

11. The USB hub according to claim 8, wherein the first retention portion is a bump, and the second retention portion is constituted by sliding grooves disposed along the periphery of the second opening and a plurality of retention recesses concavely disposed on a side wall of the sliding groove.

12. The USB hub according to claim 11, wherein the sliding grooves surround half of the periphery of the second opening, and there are three retention recesses each disposed on the two sides and the center of the sliding groove, respectively.

13. The USB hub according to claim 8, wherein the connecting portion of the fastening member couples to the first opening of the first component and the elastic hooking portion hooks up to the second opening of the second component.

14. The USB hub according to claim 8, wherein the connecting portion of the fastening member couples to the second opening of the second component and the elastic hooking portion hooks up to the first opening of the first component.

15. The USB hub according to claim 8, wherein the connecting portion of the fastening member is a ring, and the elastic hooking portion is an extending arm disposed at one side of the ring and having a protruding wedge disposed at the end thereof.

16. The USB hub according to claim 8, wherein the first component comprises a protruding ring surrounding the first opening while the second component has a recessive ring surrounding the second opening for corresponding to the protruding ring.
